(19) United States
(12) Patent Application Publication
(10) Pub. No.: US 2022/0148545 A1
(43) Pub. Date: May 12, 2022

(54) MUSICAL INSTRUMENT REST

(71) Applicant: Thomas Porter, Deerfield Beach, FL (US)

(72) Inventor: Thomas Porter, Deerfield Beach, FL (US)

(21) Appl. No.: 16/883,540

(22) Filed: May 26, 2020

(51) Int. Cl. G10G 5/00; G10D 1/08

(52) U.S. Cl. CPC G10G 5/00; G10D 1/08

(57) ABSTRACT

A musical instrument rest for attachment to an instrument having a neck. The rest provides a buffer between the instrument and a surface. The rest has an instrument side, surface side and a thickness between said instrument side and said surface side. The surface side being adapted to contact the surface in order to prevent damage to the surface. The thickness being compressible and wherein the rest is adapted to be attached to the musical instrument in the area of the neck. The weight of the instrument pressing the rest against the wall surface provides a frictional force to hold the rest and the headstock against the wall surface without damaging the wall surface. The frictional force will prevent the instrument from sliding or falling down. The compressibility of the rest will prevent damage to the wall surface.

### BACKGROUND

The present invention generally relates to musical instruments with necks. More specifically, the present invention relates to a rest for use with a musical instrument with a neck.

It is very common for a guitar/stringed instrument user to lean the instrument against a wall or other surface, either for short or long periods of time. Doing this puts the instrument at risk of falling, an experience almost all guitar owners have experienced. Also, there is a potential for damage to the wall. Most stringed instruments have a body, a neck extending from the body and a headstock extending from the neck. The headstock usually has tuning pegs extending from the headstock. What is needed is a simple device to install on the instrument which allows the instrument to rest/lean safely, prevents the instrument from falling and protects the wall.

It is an object of the present invention to provide an instrument rest that is simple to install, prevents the instrument from falling and protects the surface that the instrument contacts.

### SUMMARY

A musical instrument rest for attachment to an instrument having a neck. The rest provides a buffer between the instrument and a surface. The rest has an instrument side, surface side and a thickness between said instrument side and said surface side. The surface side being adapted to contact the surface in order to prevent damage to the surface. The thickness being compressible and wherein the rest is adapted to be attached to the musical instrument in the area of the neck.

### BRIEF DESCRIPTION OF DRAWINGS

FIG. 1 is a perspective view of a rest and instrument according to the present invention.

FIG. 2 is an exploded perspective view of a rest and instrument according to the present invention.

FIG. 3 is a perspective view of a rest according to the present invention.

FIG. 4 is a perspective view of a rest according to the present invention.

FIG. 5 is a perspective view of a rest according to the present invention.

FIG. 6 is an exploded perspective view of a rest and instrument according to the present invention.

FIG. 7 is a perspective view of a rest and instrument according to the present invention.

FIG. 8 is a perspective view of a rest according to the present invention.

### DETAILED DESCRIPTION

The present invention is musical instrument rest for attachment to the headstock or neck of a musical instrument. Musical instruments that have a headstock and neck are usually a stringed instrument. The rest provides support to the musical instrument when the musical instrument is leaned against a surface such as a wall. The rest provides a low-cost way to secure the instrument against a surface without fear of the instrument sliding or falling down. The rest is also for protecting the surface from damage often caused by the instrument when leaned against a surface.

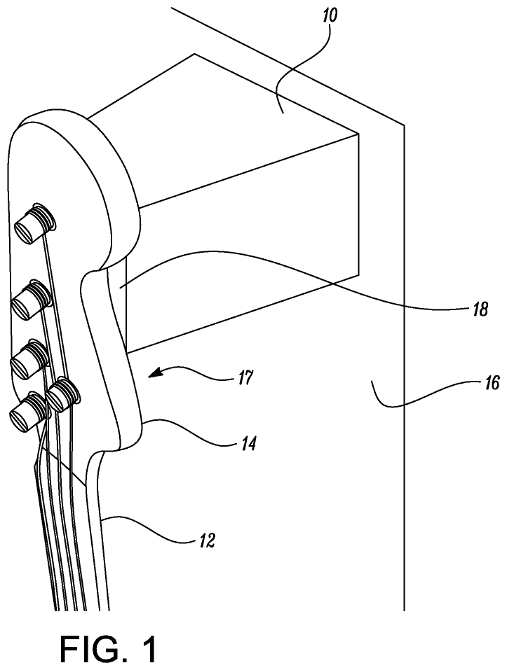

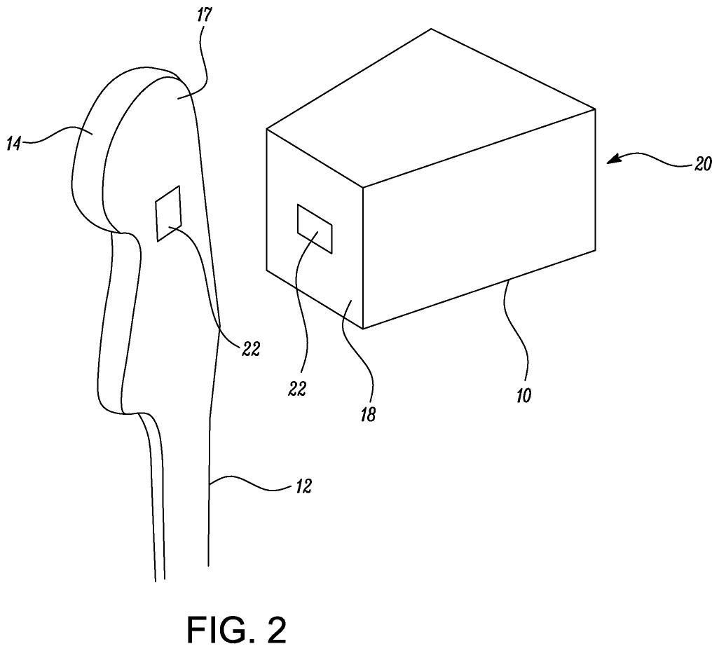

FIGS. 1-7 show different embodiments of the musical instrument rest 10. FIG. 1 shows the neck 12 and headstock 14 of an instrument, whereby the headstock 14 is leaning against a wall surface 16. The rest 10 is attached to the back 17 of the headstock 14 and provides a contact buffer between the headstock 14 and the wall surface 16. The rest 10 is made of a soft material that is slightly compressible. The rest 10 compresses when the rest 10 contacts the wall surface 16 due to the weight of instrument. The weight of the instrument pressing the rest 10 against the wall surface 16 provides a frictional force to hold the rest 10 and the headstock 14 against the wall surface 16 without damaging the wall surface 16. The frictional force will prevent the instrument from sliding or falling down. The compressibility of the rest 10 will prevent damage to the wall surface 16. FIG. 2 shows one embodiment of attachment of the rest 10 to the headstock 14 using an attachment fastener. The rest 10 has an instrument side 18 and a wall surface side 20. A hook and loop fastener 22 is applied to the headstock 14 and instrument side 18 of the rest 10 as the attachment fastener. The rest 10 is then connected to the headstock 14 using the hook and loop fastener 22. It is envisioned that other attachment methods could be used between headstock 14 and the rest 10 as the attachment fastener. For example, magnets or snap fasteners attached to the instrument and rest 10.

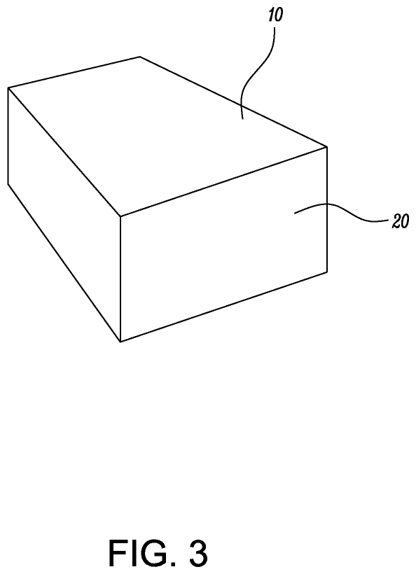

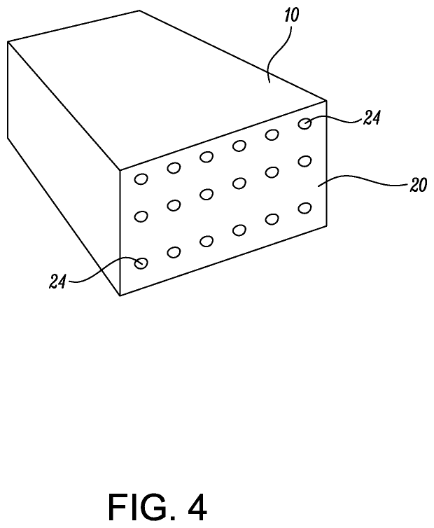

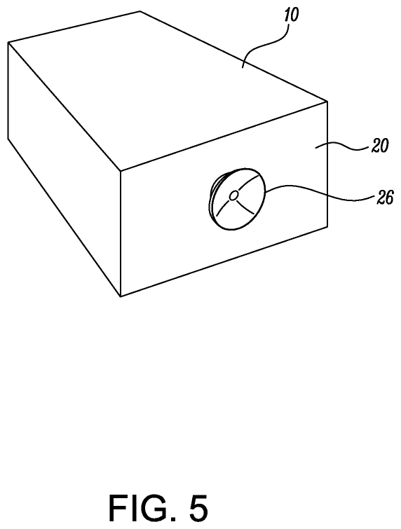

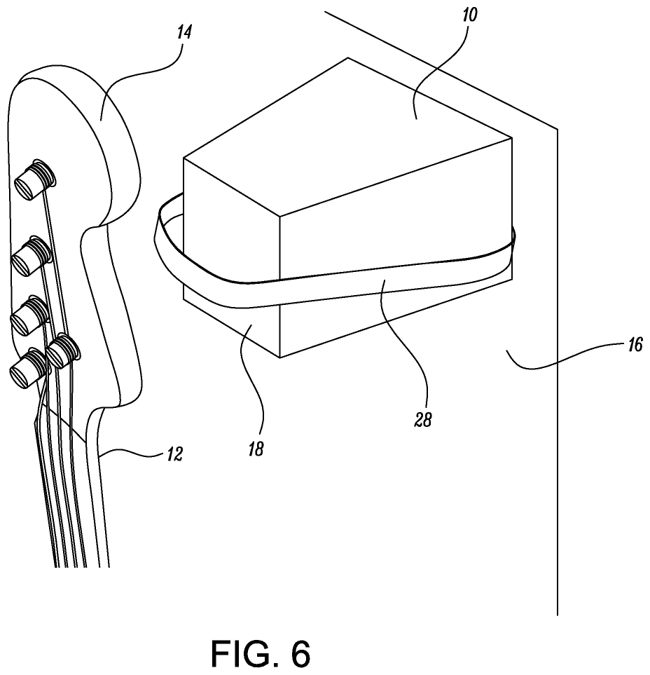

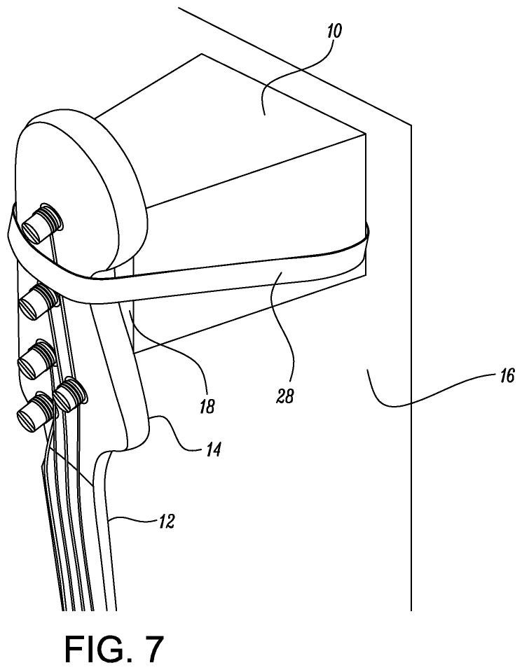

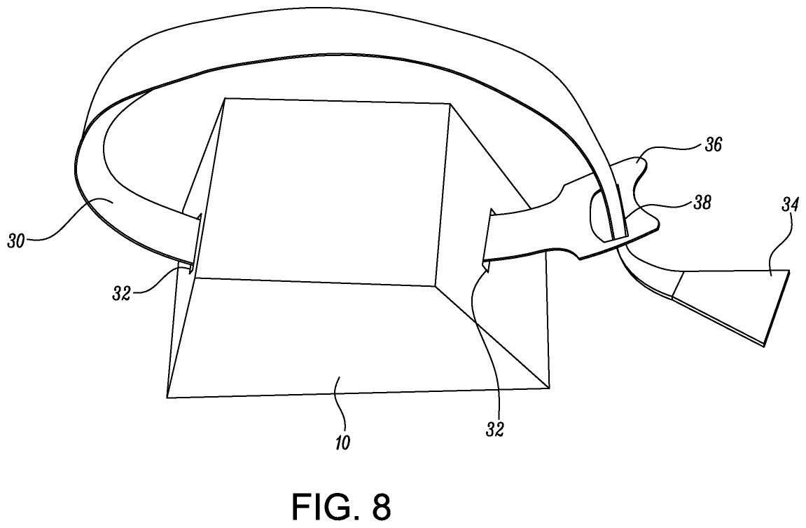

FIGS. 3-5 show different embodiments of the rest 10. FIG. 3 shows the rest 10 as a trapezoid, where the larger wall surface side 20 contacts the wall surface 16 to increase contact area with the wall surface 16. FIG. 4 shows the rest 10 with flexible nubs 24 extending from the wall surface side 20. The nubs 24 reduce the contact surface that contacts the wall surface 16. The nubs 24 can be of a compressible material and/or rubbery material that contacts the wall surface 16. FIG. 5 shows a suction cup 26 extending from the wall surface side 20 of the rest 10 to contact wall surface 16 more aggressively. On other embodiments of the rest 10, the outside material of the rest 10 can have a rubbery or tacky material to contact the wall surface 16. FIGS. 6-7 show another embodiment of attachment of the rest 10 to the headstock 14 with a strap 28 as the attachment fastener. The strap 28 is attached to the rest 10, as shown in FIG. 6. The strap 28 can be placed about the headstock 14 as shown in FIG. 7 or elsewhere on the neck 12 to attach the rest 10 to the instrument. The strap 28 can be adjustable to adjust the fit of the rest 10 to the instrument. The strap 28 can be an elastic band. FIG. 8 shows the strap 30 with two ends going through a strap slot 32 in the rest 10 made of foam. The strap 30 can be moved through the rest 10 for easy adjustment. The strap 30 has a fastening end 36 to which a fastening slot 38 that receives the other end 34 of the strap 30. Hoop and loop fasteners can be part of the strap 30 to secure the strap 30 to itself. Any embodiment of the rest 10 can be made of foam. Any embodiment of the rest 10 should be thick enough between the instrument side 18 and the wall surface side 20 so that the pegs of the headstock 14 that might stick out do not contact the wall surface 16.

While different embodiments of the invention have been described in detail herein, it will be appreciated by those skilled in the art that various modifications and alternatives to the embodiments could be developed in light of the overall teachings of the disclosure. Accordingly, the particular arrangements are illustrative only and are not limiting as to the scope of the invention that is to be given the full breadth of any and all equivalents thereof.

1. A musical instrument rest for attachment to an instrument having a neck and a headstock that provides a buffer between the instrument and a surface, the musical instrument rest comprising:
the musical instrument rest having an instrument side, surface side and a thickness between said instrument side and said surface side, said surface side being adapted to contact the surface side in a way that prevents damage to the surface side;
said thickness being compressible; and
wherein said rest is adapted to be attached to the musical instrument in the area of the headstock; and
said rest is a trapezoidal shape, where a larger bottom is the surface side and a smaller and flat top is the instrument side.

2. The musical instrument rest of claim 1, wherein said rest is attached to the instrument using an attachment fastener between said instrument side and the instrument.

3. The musical instrument rest of claim 2, wherein said attachment fastener is a hook and loop fastener.

4. The musical instrument rest of claim 1, wherein said surface side includes a nonmarring layer that provides friction between the said surface side and the surface.

5. The musical instrument rest of claim 4, wherein said non-marring layer is a tacky surface.

6. The musical instrument rest of claim 4, wherein said non-marring layer is a plurality of nubs extending from said surface side.

7. The musical instrument rest of claim 6, wherein said plurality of nubs are compressible.

8. (canceled)

9. The musical instrument rest of claim 1, wherein said rest includes a strap to attach said rest to the instrument.

10. The musical instrument rest of claim 1, wherein the instrument has a headstock extending from the neck, and wherein said rest is adapted to be attached to the headstock using said instrument side.

11. The musical instrument rest of claim 10, wherein said rest is attached to the instrument using an attachment fastener between said instrument side and the instrument.

12. The musical instrument rest of claim 11, wherein said attachment fastener is a hook and loop fastener.

13. The musical instrument rest of claim 10, wherein said surface side includes a non-marring layer that provides friction between the said surface side and the surface.

14. The musical instrument rest of claim 13, wherein said non-marring layer is a tacky surface.

15. The musical instrument rest of claim 13, wherein said non-marring layer is a plurality of nubs extending from said surface side.

16. The musical instrument rest of claim 15, wherein said plurality of nubs are compressible.

17. The musical instrument rest of claim 10, wherein said rest is a trapezoidal shape, where the larger bottom is the surface side and smaller top is the instrument side.

18. The musical instrument rest of claim 10, wherein said rest includes a strap to attach said rest to the instrument.
